(19) United States
(12) Patent Application Publication
(10) Pub. No.: US 2003/0125041 A1
(43) Pub. Date: Jul. 3, 2003

(54) Method for establishing communication relations

(76) Inventor: Friedrich Stippel, Puchheim (DE)

Correspondence Address: MORRISON & FOERSTER LLP, 1650 TYSONS BOULEVARD, SUITE 300, MCLEAN, VA, 22102, US

(21) Appl. No.: 10/221,358

(22) PCT Filed: Aug. 27, 2001
(86) PCT No.: PCT/DE01/03256

(30) Foreign Application Priority Data
Aug. 29, 2000 (DE) 100 42 353.1

(51) Int. Cl. H04Q 7/20

(52) U.S. Cl. 455/455; 455/450; 455/453

(57) ABSTRACT

This invention relates to a method for establishing communications relations. A plurality of subscribers (PA) of a communication network (KN) are allocated to at least one group (GRP). The invention is further characterized in that before a communication relation (kv) is established within the group (GRP), the communication relations that are or that can be established within the group (GRP) are checked to determine whether they exceed a predetermined maximum number (n_max). If they exceed said number, the communication relation (kv) is not established.

In current communications networks, it is known to set up so-called super-imposed or overriding communications networks within public networks, in which several SUB-networks arranged in a public communications network, e.g., voice and data networks divided up among several company locations, are brought together, by way of the public communications network, to form an overriding communications network or company network. Special requirements with regard to availability, access, and costs are set for such overriding or super-imposed communications networks. In order to keep the operating costs of such overriding communications networks low, the scope of resources made available by the public communications network for an overriding communications network is restricted, for example, by means of a pre-determined line size or bundle size.

In order to implement overriding communications networks, individual bundles of lines or leased lines are used, by means with which the individual locations, i.e., SUB-networks are connected. Within overriding telecommunications networks, subscriber connections with different kinds of structures can be connected, the subscriber connections being structured

as an ISDN basic connection and/or

as an ISDN primary multiplex connections and/or

as a subscriber connection implementing an XDSL transmission method and/or

as a cordless subscriber connection for connecting a cordless communications terminal and/or

as a subscriber connection in conformity with the wireless telephone system, for connecting a mobile, wireless communications terminal.

Within current communications networks or telephone networks, signaling for establishing and ending 64 kbit working channel connections for controlling ISDN services takes place on the basis of the ITU-T signaling system No. 7, also referred to as SS No. 7.

The actual task of the signaling system No. 7 is the exchange of signaling messages within the communications networks. The user parts within the reference model exchange the signaling messages. A differentiation is made, depending on the type of signaling messages, for example between the telephone user part TUP, the data user part DUP, the ISDN user part ISUP, and the broadband ISDN user part B-ISUP. The TUP was implemented as the first log-on in the signaling method No. 7. The ISUP was defined on the basis of the TUP, for a general determination of the ISDN and to establish the signaling within the ISDN. The B-ISUP, as the latest application, resulted from the ISUP for uses within ATM-based networks. The main tasks of the ISUP are:

establishing and ending working channel connections,

handling signaling for service features,

coupling two “logical” signaling connections (e.g., during the transition from the national into the international network).

The ISDN user part uses the message transfer part MTP and the control part for signaling connections SCCP, Layer 4 directly, in other words, the ISUP itself is to be assigned to the layer 4 to 7 in the OSI reference model. The ISDN user part controls both the segment-by-segment signaling for reaching the destination, and the end-to-end signaling relationship between the origination switching center and the destination switching center. The path for the working channel connection and the signaling connection is sought using the segment-by-segment signaling, and it is established after the appropriate commands are given. All of the switching centers involved must be informed about the working channel connection, for example by switching the working channel through, while only the origination switching center and the destination switching center exchange signaling data in order to control the service features. The ISUP uses the services of the SCCP for the end-to-end signaling. The actual signaling data are exchanged in the ISDN user part. All of the subordinate layers ensure that these data are transmitted in a secure manner, and that they reach the addressed user part. End-to-end signaling of the SCCP, based on a TCAP dialog, is used for exchange of the end-to-end signaling messages for handling of the ISDN service features.

The exchange of messages of the ISDN user part with the corresponding related parameters forms the actual signaling between the ISDN switching centers as it proceeds. The messages are transferred to the control in the switching centers. The paths of the working channel connections are controlled on the basis of these messages, for example, and the coupling elements are switched through accordingly. The signaling messages of the ISUP have an established structure that contains not only a message header—with the “routing label,” “circuit identification code,” and “message type” contained in it, for the type of message, in each instance—but also required (i.e., with a fixed or variable length) and optimal parameters.

Different types of signaling messages can be transmitted, with appropriate message formats, using the USIP. In this connection, a defined message structure is prescribed for each message in the ITU-T recommendation. An example of such a signaling message is the “initial address message,” i.e., “IAM.” The signaling transaction in the signaling system No. 7 is initiated by transmitting an IAM message. It either contains the complete telephone number of the B subscriber, or at least that part of the telephone number that is required to direct traffic in the direction of the desired destination. In this connection, a working channel is made busy and, at the same time, the required properties of the respective connection are signaled.

The ISDN services made available by communications networks that conform to ISDN are divided up into normal ISDN services and supplementary services. According to ITU-T, the supplementary services are divided up into eight groups:

supplementary services related to the telephone number,

supplementary services related to the calling destination,

supplementary services for completing a call,

supplementary services for the involvement of several subscribers,

supplementary services for user groups,

supplementary services for transmission of additional data, and

supplementary services for mobility and modification.

The supplementary service for user groups, also referred to as “Community of Interest Supplementary Services,” comprises all the supplementary services that can be jointly used within the scope of users (groups). A supplementary service that can be jointly used within the scope of users (groups) is the “Multi-Level-Precedence and Preemption Service” feature or “MLPP.” The supplementary service Multi-Level Precedence and Preemption Service (MLPP) makes call handling with several priority levels available to the corresponding service users. The supplementary service MLLP is made available at the service user's request, and can relate either to the telephone number and/or to the service. For example, within the scope of the MLPP service, calls with a higher ranking, i.e., higher priority (calls with a higher priority than the priority of the call accepted previously) are forwarded to a pre-determined destination, e.g., C subscriber or inquiry station, from the service user or B subscriber, if the non-interruptable service user is busy or does not answer. As an alternative, however, an interruption of an active connection can also be forced by a higher-ranking or higher priority call, where

every subscriber of the active connection is informed about the forced interruption,

every called, interruptable subscriber or B subscriber has the possibility of confirming the forced call termination, or

if the operating means are not available, i.e., if there is a lack of free working channels or B channels, or if there is a lack of simultaneously carried connections, the connection with the lowest priority is cut off.

The “Multi-Level-Precedence and Preemption Service” or MLPP feature is mainly used in military networks.

The supplementary service MLPP is currently only defined by the ITU-T:

ITU-T I.255.3: Integrated Services Digital Network (ISDN) General Structure and Service Capabilities Multi-Level Precedence and Preemption Service (MLPP), ITU-T, Geneva, September 1990.

ITU-T Q.735: SPECIFICATION OF SIGNALING SYSTEM No. 7, STAGE 3 DESCRIPTION FOR COMMUNITY OF INTEREST SERVICES USING SS NO. 7 Clause 3—Multilevel Precedence and Preemption

The data format of the MLPP parameter transmitted within the scope of the IAM message is presented in ITU-TQ 735, Chapter 3.4.1.2.1, “Precedence Parameter—Format and Coding.” The MLPP parameter comprises six data objects, which determine the MLPP priority, i.e., the respective “Precedence Level”, the MLPP network, and the network domain, “MLPP service domain”, as well as other MLLP-specific information for the MLPP connection or MLPP communications relationship to be established, among other things.

However, the capacity of the line bundles or leased lines specifically used for implementing overriding communications networks is insufficiently utilized, because of the bundle reserves required for this purpose, and is therefore associated with a high level of economic expenditure. In addition, the administration of overriding networks is connected with a high level of operation technology and administration technology effort and expense because, among other reasons, pathways with overflow bundles are necessary for reasons of availability.

The invention is based on the task of minimizing the administration and therefore the economic expenditure for setting up and operating overriding or super-imposed communications networks. This task is accomplished by a method in accordance with the characteristics of the preamble of claim 1, by means of its characterizing features.

The essential aspect of the method according to the invention, for setting up communications relationships between subscriber connections arranged in at least one communications network and assigned to at least one group, is that in the case of a communications relationship to be established within the group, a check takes place to determine whether or not a pre-determinable, maximum number of communications relationships that can be established or have been established within the group is being exceeded. If it is determined that the maximum number has been exceeded, the communications relationship to be established is not established.

The significant advantage of the method according to the invention consists in the simple administration of super-imposed communications networks, using existing line bundles and pathways, and the avoidance of bundle losses achieved thereby. Using the method according to the invention, it is possible to save expensive leased lines for connecting communications sub-networks, and existing transmission resources of a third-party network operator can be utilized at advantageous conditions.

In accordance with an advantageous embodiment of the method according to the invention, a pre-determinable priority is assigned to the communications relationship to be established. If it is determined that the maximum number of communications relationships that can be established or have been established within the group has been exceeded, at least one communications relationship within the group that currently has a lower priority than the priority of the communications relationship to be established is determined and selected. Subsequently, the selected communications relationship is cut off or parked or held, and the communications relationship to be established is established—claim 2. The pre-determinable prioritization of communications relationships to be established ensures that urgently required transmission resources will be made available, for example, when the scope of transmission resources made available within the group, as a whole, has been exhausted. It is particularly advantageous that the scope of transmission resources that is to be assigned to a group, i.e., the maximum number of communications relationships that can be established within the group, can be designed for times of normal demand on transmission resources, or normal demand. The pre-determinable prioritization of communications relationships to be established ensures that even at times of high demand for transmission resources, peak demand, important communications relationships will be established within the group, in spite of the design of the scope of resources assigned to the group being based on normal demand, by cutting off communications relationships with a lower priority. In this way, the transmission resources made available by a communications network can be assigned or reserved in particularly “resource-optimized” manner, and as a result, the economic expenditure for setting up and operating overriding or super-imposed communications networks is kept low.

It is advantageous if at least part of the communications relationships established within the group is assigned a priority according to the ISDN supplementary service “Multi-Level-Precedence and Preemption Service” or “MLPP”—claim 5. Within the scope of this advantageous embodiment, the method according to the invention represents an expansion of the MLPP standard in the direction of overriding or super-imposed networks.

Other advantageous embodiments of the method according to the invention can be derived from the additional claims.

In the following, the method according to the invention will be explained in greater detail, on the basis of four figures. These show:

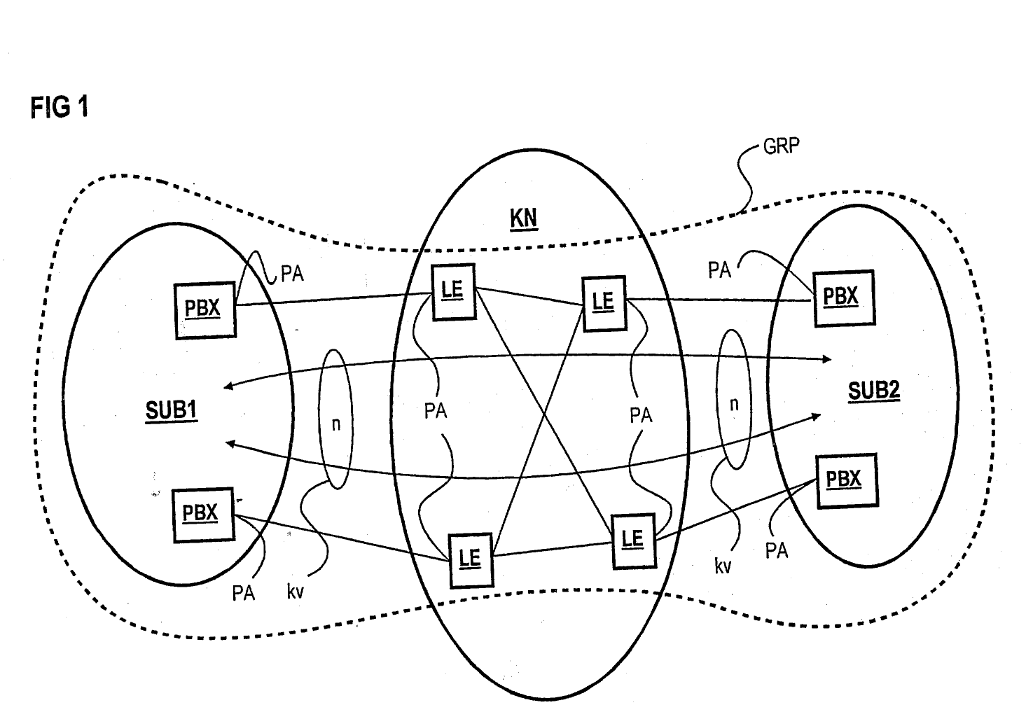

FIG. 1 an overriding communications network having several subscriber connections, in which network communications relationships between the subscriber connections are established using the method according to the invention,

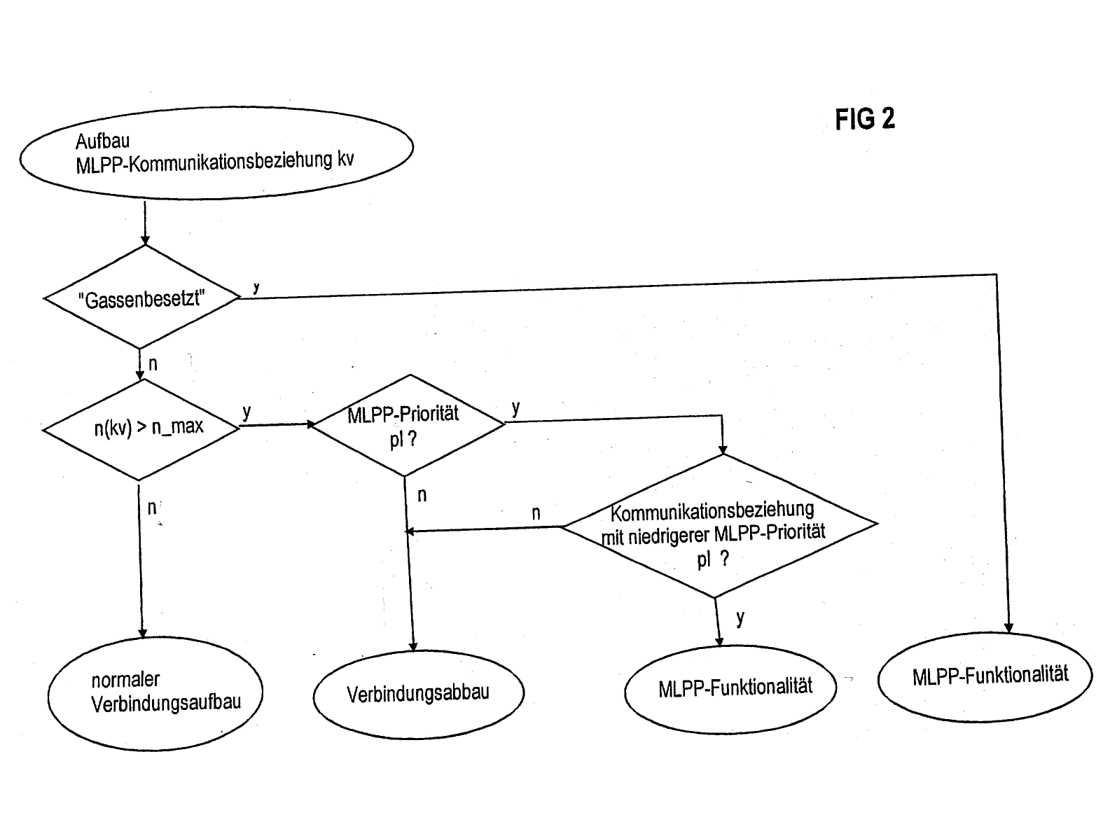

FIG. 2 the sequence of the method according to the invention during establishment of a communications relationship within the overriding communications network,

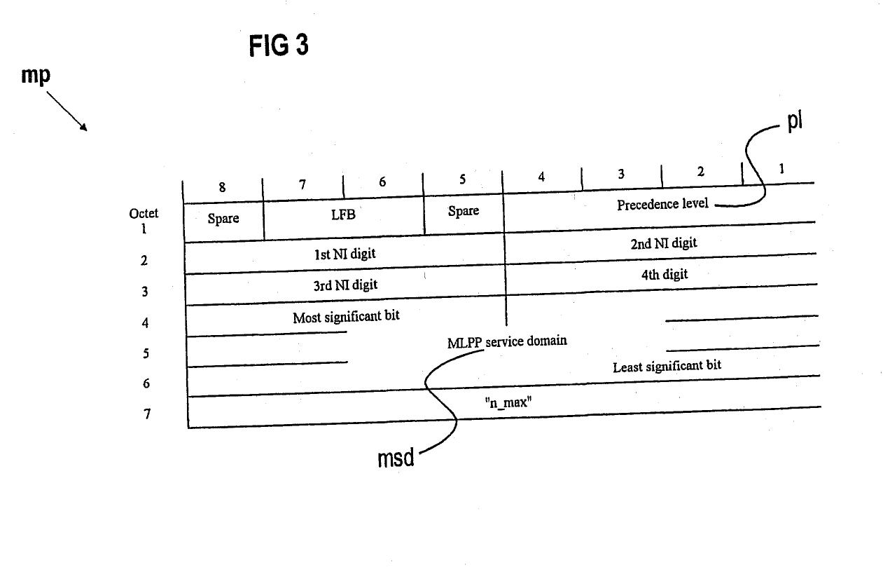

FIG. 3 a first embodiment variant of a proprietary expansion of the MLPP parameter transmitted in the IAM of the ISUP during establishment of a communications relationship within the framework of MLPP signaling,

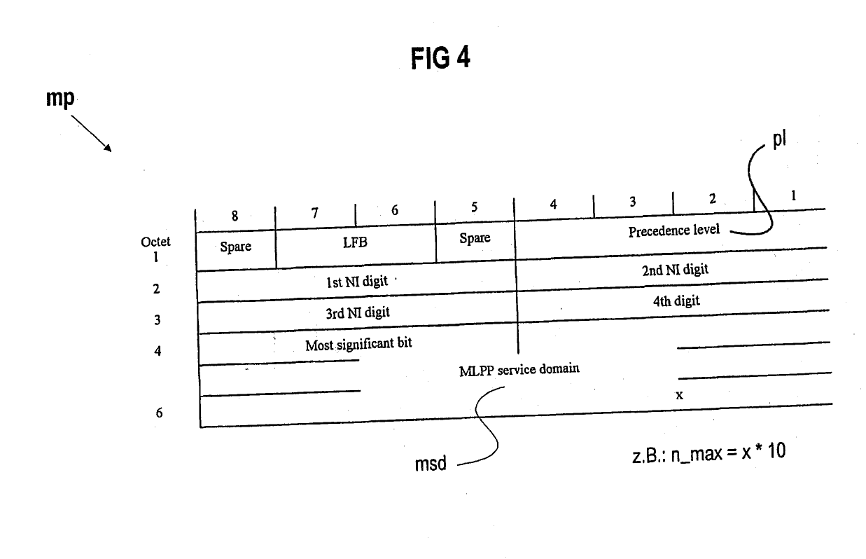

FIG. 4 a second embodiment variant of a proprietary expansion of the MLPP parameter.

FIG. 1 shows a block schematic of an exemplary arrangement of two communications sub-networks SUB 1, 2, which are brought together to form an overriding, i.e., super-imposed communications network or company network GRP, shown with a broken line in FIG. 1, by way of a public communications network KN. In this exemplary embodiment, the two communications sub-networks SUB 1, 2 represent two separate communications networks, implemented in different company locations, for example, which can be connected with one another by way of the public communications network KN. According to FIG. 1, the communications sub-networks are connected with switching devices LE assigned to the public communications network KN by way of private switching devices PBX and corresponding primary multiplex connections PA, for example. The switching devices LE that represent the public communications network are connected or intermeshed with one another.

In this exemplary embodiment, a maximum number n_max of 100 connections or communications relationships that can be carried over the public communications network KN, for example, is provided for communication, i.e., voice and data communication, between the two communications sub-networks SUB 1, 2, as defined. For this reserved scope of resources, a special, inexpensive rate schedule, for example, has been agreed between the customer, i.e., the company, and the operator of the public communications network. It is advantageous if communications relationships kv are established within the overriding communications network GRP, also referred to as a domain in the following, within the scope of MLLP signaling, “Multi-Level Precedence and Preemption (MLPP).” In this connection, the maximum number n_max of planned or permissible communications relationships foreseen for the domain GRP is signaled by means of the MLPP parameter MP in the IAM of the ISUP.

The communications relationships or connections kv currently established by way of the public communications network KN for the group or domain GRP is determined in the public switching devices LE involved in establishing the communications relationships kv or connections. If it is found, within the scope of establishing a connection, that the maximum number n_max of communications relationships that are permissible for the domain GRP and carried by way of the public communications network KN has been exceeded, the connection is denied. If the communications relationship to be newly established has an MLPP priority pl assigned to it, a check takes place to determine whether or not there is a communications relationship or connection kv with a lower MLPP priority pl. If a currently existing communications relationship kv, established by way of the public communications network KN, with a lower MLPP priority pl is found, this relationship is cut off and the new communications relationship is established. Otherwise, the connection is denied, i.e., the connection is broken off. In this way, the number n-max of maximum connections or communications relationships established within the group or domain GRP at the same time, by way of the public communications network KN, is adhered to. In this connection, the determination and possible cut-off of an existing connection kv takes place using the existing MLPP functionality.

In accordance with an alternative embodiment variant, when the establishment of a communications relationship kv by way of the public communications network is initiated by a switching device LE, the number n of communications relationships currently established within the domain GRP by way of this switching center LE and the public communications network KN is determined. If it is found, within the framework of establishing a connection, that the maximum number n-max of communications relationships carried by way of this switching center LE over the public communications network has been exceeded, the connection kv is denied. This alternative embodiment variant can be implemented with less administration technology effort and expense, since when establishing a connection, only the current number of communications relationships being carried by way of the switching center LE initiating the establishment of the respective connection has to be determined, not the current number of communications relationships being carried within the domain GRP in total, by way of the communications network KN.

FIG. 2 shows the sequence of the method according to the invention for a connection or communications relationship to be established within the domain GRP, in the form of a self-explanatory flow chart. In this case, the method according to the invention is based on existing MLPP functionality. According to the, invention, the MLPP logic is expanded to include an additional inquiry concerning the number n-max of connections that have been established within the domain GRP at the same time. According to FIG. 2, a communications relationship with low MLPP priority is found in the switching technology state “path busy” within the domain GRP. If the state “path busy” does not exist, the number n(kv) of communications relationships or connections currently established within the domain GRP by way of the public communications network KN is checked.

As an alternative, the number n(kv) of communications relationships or connections currently established within the domain GRP by way of the switching center LE that initiates the establishment of the connection can be checked.

If a certain pre-determinable maximum number n_max is exceeded, it is determined whether a priority pl is assigned to the communications relationship kv to be established. If the communication to be set up has an MLPP priority pl, the communications relationship is again set up within the framework of the already known MLPP functionality. If the communications relationship kv does not have any MLPP priority pl assigned to it, establishment of the connection is denied.

FIG. 3 shows a proprietary expansion, as a first embodiment variant, of the MLPP parameter mp transmitted in the IAM of the ISUP during establishment of a communications relationship within the framework of MLPP signaling. In this embodiment variant, the connection data representing the maximum number n-max of communications relationships that can be established by way of the public communications network KN are added as an additional 7^{th} octet at the MLPP parameter mp.

FIG. 4 shows another embodiment variant of a proprietary expansion of the MLPP parameter mp. In the expansion shown in FIG. 4, the connection data representing the maximum number n-max of communications relationships permissible within the domain GRP are encoded in the sixth octet of the MLPP parameter, in the “MLLP-Service-Domain” data with a data size of 3 bytes. For example, the value x is encoded as a binary value, e.g., having a size of 4 bits, into the “MLPP-Service-Domain” data, the binary value x representing x*10=n-max maximum permissible communications relationships, for example, within the domain GRP. However, in this connection, the number of maximum addressable domains is reduced accordingly within the framework of MLPP signaling.

1. Method for establishing communications relationships (kv) between subscriber connections (PA) arranged in at least one communications network (KN) and assigned to at least one group (GRP),
characterized in that
if a communications relationship (kv) is to be established within the group (GRP), a check takes place to determine whether or not a pre-determinable maximum number (n_max) of communications relationships (kv) that can be established or have been established within the group (GRP) are being exceeded,
if it is determined that the maximum number (n_max) has been exceeded, the communications relationship (kv) to be established is not established.

2. The method as recited in claim 1,
characterized in that
a pre-determinable priority (pl) is assigned to the communications relationship (kv) to be established,
if it is determined that the maximum number (n_max) of communications relationships (kv) that can be established or have been established within the group (GRP has been exceeded, at least one communications relationship within the group (GRP) that currently has a lower priority (pl) than the priority of the communications relationship to be established is determined and selected,
the selected communications relationship is cut off or parked or held, and
the communications relationship to be established is established.

3. The method as recited in claim 2,
characterized in that
if no communications relationship that currently has a lower priority (pl) than the priority (pl) of the communications relationship to be established is found, the communications relationship to be established is not established.

4. The method as recited in one of the preceding claims,
characterized in that
connection data (n-max) representing the maximum number of communications relationships that can be established within the group (GRP) are transmitted or signaled when the communications relationship (kv) is established.

5. The method as recited in one of the preceding claims,
characterized in that
at least part of the communications relationships (kv) established within the group (GRP) and/or the communications relationship to be established, in each instance, is assigned a priority (pl) according to the ISDN supplementary service “Multi-Level-Precedence and Preemption Service” or “MLPP.

6. The method as recited in claim 5,
characterized in that
the connection data (n-max) are inserted into the MLPP parameter (MP) when the MLPP communications relationship is established.

7. The method as recited in claim 6,
characterized in that
the connection data (n-max) are inserted into the MLPP parameter (MP) as an additional seventh octet.

8. The method as recited in claim 6,
characterized in that
the connection data (n-max) are inserted or encoded into the data (msd) representing the “MLPP Service Domain.”

9. The method as recited in one of the preceding claims,
characterized in that
establishment of the communications relationship is initiated by a switching device (LE) assigned to the communications network (KN),
when the communications relationship (kv) is being established, a check is undertaken as to whether the predetermined number (n-max) of communications relationships that can be established or have been established by way of the initiating switching device (LE) is being exceeded, and if it is found that the maximum number is being exceeded, the communications relationship is not established.
